(19) United States
(12) Patent Application Publication
(10) Pub. No.: US 2015/0154292 A1
(43) Pub. Date: Jun. 4, 2015

(54) RECIRCULATING ON-LINE TRAFFIC, SUCH AS WITHIN A SPECIAL PURPOSE SEARCH ENGINE

(71) Applicant: Yahoo! Inc., Sunnyvale, CA (US)

(72) Inventor: Prabhaker Sharma, Bangalore Karnataka (IN)

(73) Assignee: Yahoo! Inc., Sunnyvale, CA (US)

(21) Appl. No.: 14/095,571

(22) Filed: Dec. 3, 2013

(51) Int. Cl. G06F 17/30

(52) U.S. Cl. CPC G06F 17/30864; G06F 17/30312

(57) ABSTRACT

Example methods, apparatuses, and/or articles of manufacture are disclosed that may be implemented, in whole or in part, using one or more computing devices to facilitate or support one or more processes or operations for recirculating on-line traffic within a special purpose search engine.

### BACKGROUND

1. Field

The present disclosure relates generally to on-line content management systems.

2. Information

The Internet is widespread. The World Wide Web or simply the Web, provided by the Internet, is growing rapidly, at least in part, from the large amount of content being added seemingly on a daily basis. A wide variety of content in the form of stored signals, such as, for example, web pages, text documents, images, audio files, video files, or the like is continually being identified, located, retrieved, accumulated, stored, or communicated. With a large amount of content being available or accessible over the Internet, a number of tools or services may often be provided to users so as to allow for copious amounts of content to be searched in an efficient or effective manner. For example, service providers may allow users to search the Web or other like networks using search engine content management systems or search engines. In certain instances, search engines may enable a user to search the Web by inputting one or more search queries, for example, so as to try to locate or retrieve content of interest.

More effectively or efficiently identifying or locating content of interest may facilitate or support information-seeking behavior of users, for example, and may lead to an increased usability of a search engine. In addition to retrieving content, such as one or more electronic documents, for example, search engines may employ one or more functions or processes to rank retrieved documents using one or more ranking measures. In some instances, a ranking measure may include, for example, relevance, usefulness, popularity, recency, or the like. At times, search engines may also present retrieved content in a suitable manner, such as, for example, in an ascending or descending order of relevance, recency, etc. in response to a search query in a listing of returned search results.

In addition, special purpose search engines that focus on a particular segment of Web content (e.g., question-answering web sites, knowledge databases, etc.) continue to evolve. In some instances, a special purpose search engine, however, may suffer from lower precision or recall, insufficient content coverage, poor ranking or retrieval rate, or the like.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic diagram illustrating certain features of an implementation of an example computing environment.

FIG. 2 is a flow diagram illustrating an implementation of a process for recirculating on-line traffic.

FIG. 3 is an implementation of an example inverted index.

FIG. 4 is an implementation of an example plot illustrating various click-through rates.

FIG. 5 is a schematic diagram illustrating an implementation of a computing environment associated with one or more special purpose computing apparatuses.

FIG. 6 is a schematic diagram illustrating an implementation of a computing platform that may be employed in a client-server type interaction.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, and/or systems that would be known by one of ordinary skill have not been described in detail so as not to obscure claimed subject matter.

With advances in technology, it has become more typical to employ distributed computing approaches in which a computational problem may be divided among computing devices, including one or more clients and one or more servers, via a computing and/or communications network. A network may comprise two or more network devices and/or may couple network devices so that signal communications, such as in the form of signal packets, for example, may be exchanged, such as between a server and a client device and/or other types of devices, including between wireless devices coupled via a wireless network, for example. A network may be very large, such as comprising thousands of nodes, millions of nodes, billions of nodes, or more, as examples.

In this context, the term network device refers to any device capable of communicating via and/or as part of a network and may comprise a computing device. While network devices may be capable of sending and/or receiving signals (e.g., signal packets), such as via a wired or wireless network, they may also be capable of performing arithmetic and/or logic operations, processing and/or storing signals, such as in memory as physical memory states, and/or may, for example, operate as a server in various embodiments. Network devices capable of operating as a server, or otherwise, may include, as examples, dedicated rack-mounted servers, desktop computers, laptop computers, set top boxes, tablets, netbooks, smart phones, integrated devices combining two or more features of the foregoing devices, the like or any combination thereof. Signal packets, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices or one or more server devices, as appropriate. Along similar lines, references to a “database” are understood to mean, one or more databases and/or portions thereof, as appropriate.

It should be understood that for ease of description a network device (also referred to as a networking device) may be embodied and/or described in terms of a computing device. However, it should further be understood that this description should in no way be construed that claimed subject matter is limited to one embodiment, such as a computing device or a network device, and, instead, may be embodied as a variety of devices or combinations thereof, including, for example, one or more illustrative examples.

A network may also include now known, or to be later developed arrangements, derivatives, and/or improvements, including, for example, past, present and/or future mass storage, such as network attached storage (NAS), a storage area network (SAN), and/or other forms of computer and/or machine readable media, for example. A network may include the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures or may be compliant and/or compatible with differing protocols, such as computing and/or communication protocols (e.g., network protocols), may interoperate within a larger network. In this context, the term sub-network refers to a portion or part of a network. Various types of devices, such as network devices and/or computing devices, may be made available so that device interoperability is enabled and/or, in at least some instances, may be transparent to the devices. In this context, the term transparent refers to devices, such as network devices and/or computing devices, communicating via a network in which the devices are able to communicate via intermediate devices, but without the communicating devices necessarily specifying one or more intermediate devices and/or may include communicating as if intermediate devices are not necessarily involved in communication transmissions. For example, a router may provide a link or connection between otherwise separate and/or independent LANs.

In this context, a private network refers to a particular, limited set of network devices able to communicate with other network devices in the particular, limited set, such as via signal packet transmissions, for example, without a need for re-routing and/or redirecting such network communications. A private network may comprise a stand-alone network; however, a private network may also comprise a subset of a larger network, such as, for example, without limitation, the Internet. Thus, for example, a private network “in the cloud” may refer to a private network that comprises a subset of the Internet, for example. Although signal packet transmissions may employ intermediate devices to exchange signal packet transmissions, those intermediate devices may not necessarily be included in the private network by not being a source or destination for one or more signal packet transmissions, for example. It is understood in this context that a private network may provide outgoing network communications to devices not in the private network, but such devices outside the private network may not direct inbound network communications to devices included in the private network.

The Internet refers to a decentralized global network of interoperable networks that comply with the Internet Protocol (IP). It is noted that there are several versions of the Internet Protocol. Here, the term Internet Protocol or IP is intended to refer to any version, now known or later developed. The Internet includes local area networks (LANs), wide area networks (WANs), wireless networks, and/or long haul public networks that, for example, may allow signal packets to be communicated between LANs. The term world wide web (WWW) and/or similar terms may also be used, although it refers to a sub-portion of the Internet that complies with the Hypertext Transfer Protocol or HTTP. It is noted that there are several versions of the Hypertext Transfer Protocol. Here, the term Hypertext Transfer Protocol or HTTP is intended to refer to any version, now known or later developed. It is likewise noted that in various places in this document substitution of the term Internet with the term world wide web may be made without a significant departure in meaning and may, therefore, not be inappropriate in that the statement would remain correct with such a substitution.

Signal packets, also referred to as signal packet transmissions, may be communicated between nodes of a network, where a node may comprise one or more network devices and/or one or more computing devices, for example. As an illustrative example, but without limitation, a node may comprise one or more sites employing a local network address. Likewise, a device, such as a network device and/or a computing device, may be associated with that node. A signal packet may, for example, be communicated via a communication channel or a communication path comprising the Internet, from a site via an access node coupled to the Internet. Likewise, a signal packet may be forwarded via network nodes to a target site coupled to a local network, for example. A signal packet communicated via the Internet, for example, may be routed via a path comprising one or more gateways, servers, etc. that may, for example, route a signal packet in accordance with a target address and availability of a network path of network nodes to a target address. Although the Internet comprises a network of interoperable networks, not all of those interoperable networks are necessarily available or accessible to the public.

Although physically connecting a network via a hardware bridge is done, a hardware bridge may not typically include a capability of interoperability via higher levels of a network protocol. A network protocol refers to a set of signaling conventions for computing and/or communications between or among devices in a network, typically network devices; for example, devices that substantially comply with the protocol or that are substantially compatible with the protocol. In this context, the term “between” and/or similar terms are understood to include “among” if appropriate for the particular usage. Likewise, in this context, the terms “compatible with”, “comply with” and/or similar terms are understood to include substantial compliance and/or substantial compatibility.

Typically, a network protocol has several layers. These layers may be referred to here as a network stack. Various types of network transmissions may occur across various layers. For example, as one moves higher in a network stack, additional operations may be available by initiating network transmissions that are compatible and/or compliant with a particular network protocol at these higher layers. Therefore, for example, a hardware bridge may be unable to forward signal packets since it may operate at a layer of a network stack that does not provide that capability. Although higher layers of a network protocol may, for example, affect device permissions, user permissions, etc., a hardware bridge, for example, may typically provide little user control, such as for higher layer operations.

A VPN, such as previously described, may enable a remote device to communicate via a local network, but may also have drawbacks. A router may allow network communications in the form of network transmissions (e.g., signal packets), for example, to occur from a remote device to a VPN server on a local network. A remote device may be authenticated and a VPN server, for example, may create a special route between a local network and the remote device through an intervening router. However, a route may be generated and/or also regenerate if the remote device is power cycled, for example. Also, a VPN typically may affect a single remote device, for example, in some situations.

Some example methods, apparatuses, and/or articles of manufacture are disclosed herein that may be used, in whole or in part, to facilitate or support one or more processes or operations for recirculating on-line traffic, such as within a special purpose search engine, for example. As used herein, “special purpose search engine” or “vertical search engine” may refer to a search engine that focuses on a specific segment and/or area of on-line content and/or used, at least in part, for content searches within a particular domain and/or sub-domain. A special purpose search engine may focus, for example, on a set of topics, specialties, concepts, media type or genre, industry, geography, or the like, or any combination thereof. A specific segment and/or area of on-line content may include, for example, knowledge-type content (e.g., legal, medical, sports, financial, etc. information), question-answering content (e.g., topical subjects, etc.), shopping content, travel content, etc. or any combination thereof. Of course, these are merely examples relating to a special purpose search engine and specific segment and/or area of on-line content, and claimed subject matter is not so limited.

As discussed below, in an implementation, to improve search results, including vertical search results, for example, instead of or in addition to text-based content matching, a special purpose search engine or vertical search engine associated with an on-line property, for example, may utilize, in whole or in part, a corpus of related content referred via a search query. In this context, “vertical search results” may refer to search results identified and/or located via a special purpose search engine or vertical search engine, and “content” may refer to any expression, realization, and/or communication of generated and/or adapted information, knowledge, experience, or thing, such as represented via one or more stored digital signals, for example. In some instances, content may include digital content associated with one or more web pages and/or on-line properties of a particular service provider, such as Yahoo!® (e.g., www.yahoo.com), as one possible example.

In some instances, a corpus of related content referred via a search query may, for example, facilitate or support recirculation of on-line traffic within a special purpose search engine (e.g., internally, etc.). Here, “recirculation” of on-line traffic may refer to a process of continual and/or otherwise suitable utilization of a special purpose search engine, such as without going back to or otherwise accessing a general purpose search engine (e.g., Yahoo!®, Google®, Bing®, etc.), for example. A “general purpose search engine” may refer to a search engine that focuses on general on-line content, such as associated with the World Wide Web, for example, rather than on a specific segment and/or area of on-line content. “On-line” may refer to a type of a communication that may be implemented via one or more communications networks, such as, for example, the Internet, an intranet, a communication device network, or the like. Communications networks may comprise, for example, a wireless network, wired network, or any combination thereof. Recirculation of on-line traffic within a special purpose search engine may, for example, improve usability of an on-line property and/or search engine, strengthen user loyalty, expand content coverage, increase revenue, or the like.

An “on-line property” or “property,” as the terms used herein, may be used interchangeably and may refer to a collection of on-line content that may have an affiliation-type relationship with a particular service provider and/or organized or otherwise grouped together, such as by category, topic, theme, format, activity, etc., or any combination thereof. In some instances, an on-line property may include, for example, a domain-related collection of content and/or resources, though claimed subject matter is not so limited. As a way of illustration, a service provider, such as, for example, Yahoo!® (e.g., www.yahoo.com) may feature one or more on-line properties (e.g., via a portal or landing page, etc.) that may typically, although not necessarily, comprise separate domains and/or sub-domains, such as Yahoo!® Mail (e.g., http://mail.yahoo.com), Yahoo!® News (e.g., http://news.yahoo.com), Yahoo!® Sports (e.g., http://sports.yahoo.com), Yahoo!® Finance (e.g., http://finance.yahoo.com), Yahoo!® Answers (e.g., http://answers.yahoo.com), etc., just to name a few examples. On-line properties may be enabled and/or otherwise supported by one or more special purpose computing platforms and/or servers (e.g., back-end, etc.), dedicated or otherwise. Generally, on-line properties may, for example, be presented (e.g., to a user, etc.) via a dynamic compilation of electronic documents, images, hyperlinks, selectable tabs, icons, or like content listed in a main portal or home page, just to illustrate one possible implementation. At times, on-line properties may form a network of related or interrelated web sites, web pages, portal pages, home pages, or like electronic documents, centrally or separately-managed and/or searched, such as via a special purpose search engine, for example. Of course, these are merely examples relating to on-line properties, and claimed subject matter is not limited in this regard.

Typically, a search engine, special purpose or otherwise, may comprise a content retrieval computing platform that may, for example, help a user to locate and/or retrieve on-line content, such as one or more web documents of a particular interest. As used herein, the terms “web document” or “electronic document” may be used interchangeably and may refer to one or more digital signals, such as communicated and/or stored signals, for example, representing any content including a source code, text, image, audio, video file, or the like. Web documents may, for example, be processed by a special purpose computing platform and may be played and/or displayed to or by a user and/or client. The terms like “user” or “client” may be used interchangeably herein. At times, web documents may include one or more embedded references or hyperlinks to images, audio and/or video files, or other web documents. For example, one common type of reference may comprise a Uniform Resource Locator (URL). As a way of illustration, web documents may include a web page, news feed, rating and/or review post, question, answer, status update, portal, blog, e-mail, text message, hyperlink, Extensible Markup Language (XML) document, media file, web page pointed and/or referred to by a URL, etc., just to name a few examples.

A search engine may further arrange and/or present retrieved content in a variety of formats. For example, a search engine may arrange web documents in an ascending or descending order of relevance in a listing of returned search results, just to illustrate one possible implementation. Relevance of a web document to a search query may, for example, be determined based, at least in part, on an evaluation of text, characters, strings, tags, URLs, or the like within the document using one or more appropriate techniques for making relevant determinations. In some instances, a search engine may, for example, present a listing of returned search results in the form of one or more links to relevant and/or related content. Of course, these are merely details relating to search engines, and claimed subject matter is not so limited.

As was indicated, in some instances, a special purpose search engine or vertical search engine associated with an on-line property, for example, may suffer from lower precision and/or recall, poor ranking, etc. due, at least in part, to particularities of a retrieval infrastructure (e.g., text-based, etc.), lack and/or insufficiency of user feedback, or the like. For example, at times, due, at least in part, to a less than sufficient search query (e.g., misspelled, etc.) and/or redundancy of on-line content, it may take more time and/or effort for a special purpose search engine to locate and/or retrieve relevant content. In addition, in some instances, content relevance assessments may, for example, be made based, at least in part, on searching a smaller portion of content (e.g., titles, questions, etc.) rather than a larger or otherwise sufficient portion of content (e.g., titles and corresponding documents, questions and corresponding answers, etc.). At times, this may negatively impact or affect users' perception of search engine's utility, which may lead to its under-utilization, lower conversion rate (e.g., click-through rate, etc.), decreased revenue, or the like. Accordingly, it may be desirable to develop one or more methods, systems, or apparatuses that may facilitate or support more effective or more efficient retrieval of search results, including vertical search results, for example, so as to enhance users' searching experience, improve users' content-seeking and/or clicking behavior, or the like.

Thus, as alluded to previously, in some instances, on-line content referred via a search query, such as content associated with an on-line property, for example, may have a higher degree of relevance to a search query. In this context, “referral” of on-line content, search engine “referral,” “referring” on-line content, or like terms may be used interchangeably and may describe and/or refer to a process of navigating to a web page associated with an on-line property via an embedded reference that is a logical or otherwise suitable extension of a search result and/or search query. To illustrate, a user may access a suitable general purpose search engine, such as Yahoo!® or Google®, for example, and may input a search query, such as in the form of a question, just to illustrate one possible implementation. From a listing of search results returned in response to such a search query, a user may navigate to a particular web page associated with an on-line property, such as Yahoo!® Answers, for example, by clicking on a link of interest (e.g., an embedded reference, etc.) within a returned listing or query results. For this example, a logical extension of a search result and/or search query may be a clickable hyperlink descriptive of a related and/or similar question asked and/or answered by one or more other users of Yahoo!® Answers, for example. As such, content associated with Yahoo!® Answers (e.g., an answered question, etc.) may, for example, be considered to be “referred” via a search query inputted or entered by a user into a general purpose search engine (e.g., initially inputted into Yahoo!® or Google®, etc.). Of course, these are merely examples relating to referring on-line content, and claimed subject matter is not so limited.

At times, a user's activation of (e.g., clicking on, etc.) a link of interest, such as within a listing of search results returned via a general purpose search engine, for example, may indicate that linked content has a higher degree of relevance to an inputted search query. For example, a user's clicking on a link of interest may be indicative a higher ranking position of a link within a returned listing of search results (e.g., sufficient for a user to notice the link). A user's clicking on a link may also indicate that a user is sufficiently interested in a particular search query-linked content relationship (e.g., sufficient to click on the link), for example. In other words, using the Yahoo!® Answers non-limiting example above, at times, for a similar or same search query, questions clicked on by a user may be similar and/or related. More relevant questions may also have a larger number of text, characters, strings, tags, URLs, etc. in corresponding answers, for example, thus, facilitating or supporting suitable ranking. Thus, referrals of on-line content may, for example, be used, in whole or in part, to improve and/or enhance search results displayable on any suitable web page having one or more links to related content, such as a web page associated with an on-line property.

Thus, as discussed below, in an implementation, a number of search queries that refer a user to particular content of interest, such as via an activation of a link within a listing of returned search results, for example, may be collected. Based, at least in part, on collected search queries, an information structure representative of collected content, such as a search index comprising a mapping of related content to a particular search query may, for example, be generated. In some instances, a search index may comprise, for example, an inverted index. Of course, claimed subject matter is not so limited. Any suitable representation of a corpus of referred content may be utilized, in whole or in part. For an incoming search query, such as a search query inputted or entered via a special purpose search engine, for example, an inverted index may be searched, and/or related content may be located and/or retrieved. Located and/or retrieved content may have a higher degree of relevance to an incoming search query and, thus, may be presented to a user, such as via one or more links within a web page associated with an on-line property (e.g., as “Related Questions,” etc.), for example. Accordingly, as described herein, a corpus of related content referred via a search query may facilitate or support recirculation of on-line traffic within a special purpose search engine, such as by decreasing or otherwise averting user exits towards a general purpose search engine, for example.

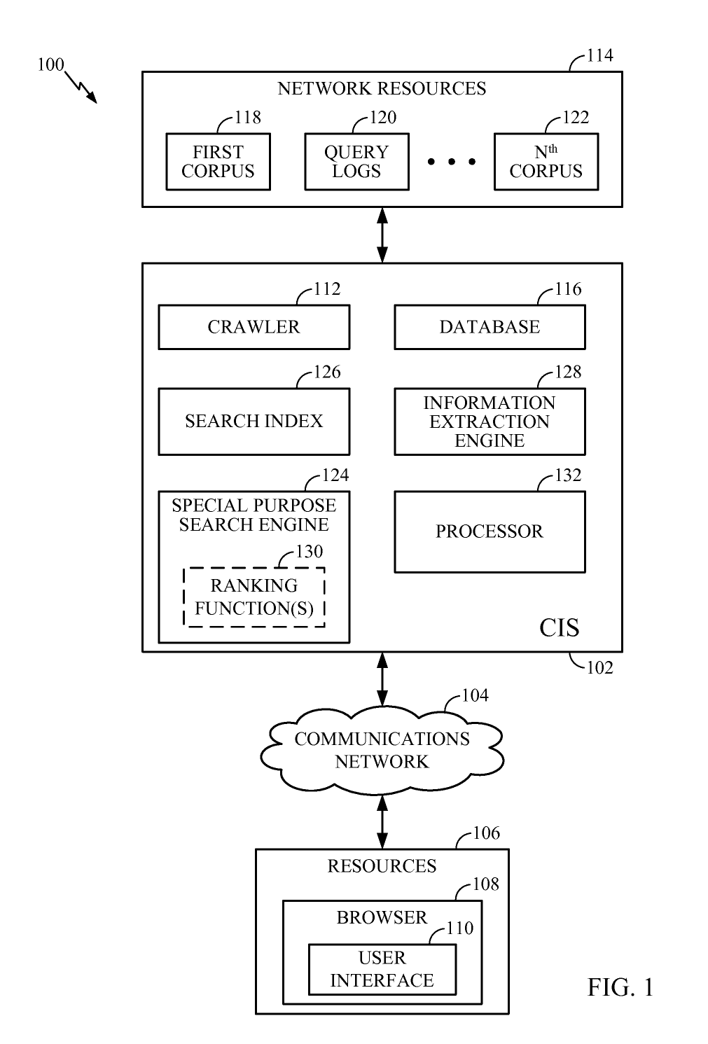

With this in mind, attention is now drawn to FIG. 1, which is a schematic diagram illustrating certain features of an implementation of an example computing environment 100 capable of facilitating or supporting, in whole or in part, one or more processes or operations for recirculating on-line traffic, such as within a special purpose search engine, for example. Computing environment 100 may be operatively enabled using one or more special purpose computing apparatuses, communication devices, storage devices, computer-readable media, applications and/or instructions, various electrical and/or electronic circuitry, components, etc., as described herein with reference to example implementations.

As illustrated, computing environment 100 may include one or more special purpose computing platforms, such as, for example, a Content Integration System (CIS) 102 that may be operatively coupled to a communications network 104 that a user may employ in order to communicate with CIS 102 by utilizing resources 106. CIS102 may be implemented in connection with one or more public networks (e.g., the Internet, etc.), private networks (e.g., intranets, etc.), public and/or private search engines, Real Simple Syndication (RSS) and/or Atom Syndication (Atom)-based applications, etc., just to name a few examples.

Resources 106 may comprise, for example, one or more special purpose computing client devices, such as a desktop computer, laptop computer, cellular telephone, smart telephone, personal digital assistant, or the like capable of communicating with or otherwise having access to the Internet via wired and/or wireless communications network 104. Resources 106 may include a browser 108 and/or a user interface 110, such as a graphical user interface (GUI), for example, that may initiate transmission of one or more electrical digital signals representing a search query. User interface 110 may, for example, interoperate with any suitable input device (e.g., keyboard, mouse, touch screen, digitizing stylus, etc.) and/or output device (e.g., display, speakers, etc.) for interaction with resources 106. Even though a certain number of resources 106 are illustrated, it should be appreciated that any number of resources may be operatively coupled to CIS102, such as via communications network 104, for example.

In an implementation, CIS 102 may employ a crawler 112 to access network resources 114 that may include, for example, any type of content, such as in the form of stored binary digital signals. In some instances, crawler 112 may comprise, for example, a focused crawler that may access a specific segment and/or area of on-line content, such as content associated with one or more on-line properties, though claimed subject matter is not so limited. For example, at times, crawler 112 may comprise and/or be integrated with a general purpose search engine and may access suitable network resources associated with the World Wide Web, just to illustrate another possible implementation. Crawler 112 may store all or part of located content (e.g., a URL, link, etc.) in a database 116, for example. As illustrated, network resources 114 may comprise, for example, a first corpus 118, one or more access and/or query logs 120, and so forth up through an Nth corpus 122, any of which may include any organized collection of any type of content accessible over the Internet and/or associated with one or more intranets. For example, first corpus 118 may comprise related content referred via a search query, and access and/or query logs 120 may comprise search queries that refer a user to content of interest. Particular examples of search queries as well as related content referred via search queries will be described in greater detail below.

In at least one implementation, network resources 114, such as first corpus 118, one or more access and/or query logs 120, etc. may comprise content associated with an on-line property, such as, for example, Yahoo!® Answers, though claimed subject matter is not so limited. For example, at times, network resources 114 may include other content, such as various knowledge databases, user-generated video and/or image content, electronic documents, audio and/or text files, or the like. Of course, these are merely examples of content that may be associated with network resources 114, and claimed subject matter is not so limited. It should be noted that, optionally or alternatively, at least a portion of content, such as, for example, search queries that refer a user to particular content of interest, content associated with a particular on-line property, etc. may be stored in database 116 or like resource operatively coupled to or otherwise associated with CIS 102.

In an implementation, CIS 102 may further include a special purpose search engine 124 supported by a suitable index, such as a search index 126, for example, and operatively enabled to search for content obtained via network resources 114, database 116, or the like. In some instances, search index 126 may comprise, for example, an inverted index that may be accessed and/or searched by a content or information extraction engine 128 so as to locate and/or retrieve related content, as will be seen. Search index 126 may be maintained in a suitable manner (e.g., updated, generated, searched, etc.) by content or information extraction engine 128 using one or more appropriate techniques, such as during indexing, caching, crawling, processing, etc. As discussed below, in some instances, content or information extraction engine 128 may collect suitable content, such as a tuple comprising, for example, a question identifier, browser cookie, and/or search queries that refer a user to particular content of interest, just to illustrate one possible implementation.

In some instances, it may be desirable to rank retrieved content so as to assist in presenting related content to a user, for example. Accordingly, CIS102 may employ one or more ranking functions, indicated generally at 130, such as to rank search results in a particular order based, at least in part, on a suitable ranking measure. For example, ranking function(s) 130 may order a listing of search results based, at least in part, on relevance, recency, usefulness, popularity, or the like. Of course, details relating to ranking measures are merely examples, and claimed subject matter is not limited in this regard. It should be noted that ranking function(s) 130 may be included, at least partially, in special purpose search engine 124, such as illustrated, or, optionally or alternatively, may be operatively coupled to it and/or CIS 102. As also illustrated, CIS 102 may include a processor 132 that may execute computer-readable code and/or instructions so as to implement one or more operations or processes associated with example environment 100.

In an implementation, in operative use, a user may access a web site that may be associated with a particular on-line property, such as Yahoo!® Answers, for example, and may submit or input a search query, such as in the form of a question, for example, by utilizing resources 106. Browser 108 may initiate communication of one or more electrical digital signals, for example, representing a search query from resources 106 to CIS 102 via communications network 104. Special purpose search engine 124 and/or content extraction engine 128 may look up search index 126 (e.g., a vertical index, etc.), for example, and may retrieve and/or locate related content as well as establish a listing of search results based, at least in part, on relevance to a search query according to ranking function(s) 130, for example. CIS 102 may then communicate a listing of returned search results to resources 106 for displaying on interface 110, such as, for example, via one or more links within an associated web page (e.g., as “Related Questions,” etc.).

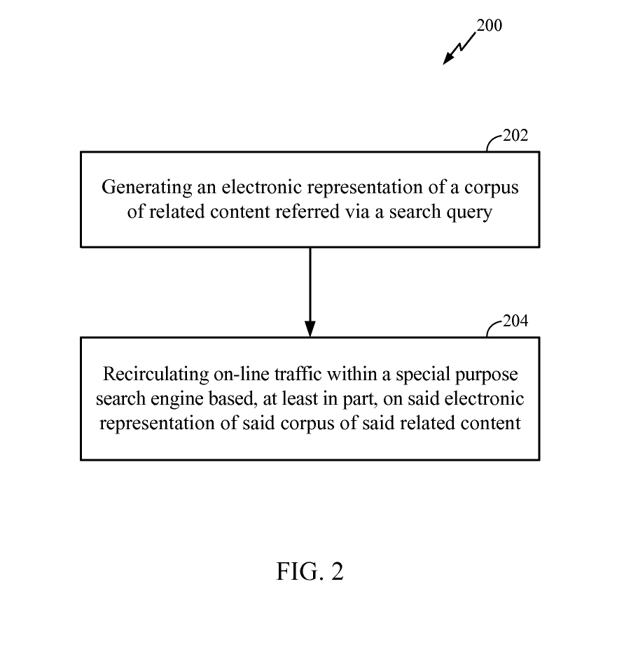

FIG. 2 is a flow diagram illustrating an implementation of an example process 200 that may be performed, in whole or in part, using one or more computing devices to facilitate or support one or more operations or techniques for recirculating on-line traffic, such as within a special purpose search engine, for example. It should be noted that content acquired and/or produced, such as, for example, input signals, output signals, operations, results, etc. associated with example process 200 may be represented via one or more digital signals. It should also be appreciated that even though one or more operations are illustrated and/or described concurrently and/or with respect to a certain sequence, other sequences and/or concurrent operations may be employed. In addition, although the description below references particular aspects and/or features illustrated in certain other figures, one or more operations may be performed with other aspects and/or features.

Example process 200 may begin, for example, at operation 202, with generating an electronic representation of a corpus of related content referred via a search query. More specifically, a number of search queries that refer a user to particular content of interest, such as via an activation of a link, for example, may be collected. Search queries may be collected over any suitable period of time. In some instances, a one-year period may, for example, be used or otherwise considered, just to illustrate one possible implementation. Claimed subject matter is not so limited, of course. For example, at times, a six-month period, if suitable and/or desired, may prove relatively beneficial. A time period may depend, for example, on processing resources, available memory, desired scalability, applicable retrieval function, amount of content overlap, implementation, or the like.

In some instances, a number of search queries referring a user to particular content of interest may be relatively large. At times, this may, for example, negatively affect associated computing and/or processing resources, usable and/or available memory, or the like. In addition, a larger number of collected search queries may not necessarily yield a higher relevance of related content. This may, however, introduce complexity with respect to content indexing, search index accessibility and/or performance, or the like. Accordingly, in some instances, a query collection time period may, for example, be subdivided into a number of relatively smaller periods, such as of equal or otherwise suitable lengths, for example. Search queries collected during smaller time periods may be merged in a suitable manner, such as discussed below, for example, for more effective or efficient processing, use of memory resources, content indexing, or the like.

For example, in at least one implementation, search queries may be collected and/or processed on a monthly basis and subsequently merged so as to cover a suitable time period, such as a one year time period, for example, though claimed subject matter is not so limited. Based, at least in part, on collected search queries, a tuple comprising a question identifier, browser cookie, and a search query document having a number of search queries that refer a user to particular content of interest, such as a particular question, for example, may be created. Search queries associated with a search query document may, for example, be processed in a suitable manner. For example, redundant search queries, such as queries originating from the same browser, exceeding a suitable length, queries in different languages, etc. may be identified and/or pruned using one or more appropriate techniques. As discussed below, search queries that may not provide incremental value, such as with respect to a suitable retrieval feature, for example, may be removed and/or discarded. In some instances, a term frequency-inverse document frequency (TFIDF)-type feature may, for example, be employed, in whole or in part, or otherwise considered as a suitable retrieval feature, just to illustrate one possible implementation. Remaining search queries may, for example, be processed in a suitable manner, such as via normalization, stemming (e.g., via a KStem token filter, etc.), stop word filtering and/or removal, tokenization, or like text processing techniques.

According to an implementation, processed search queries may be merged, such as on a per-question basis, for example. Search queries may, for example, be randomly shuffled so as to reduce or avoid bias that may arise due, at least in part, to time of their occurrence, collection, referral, or the like. For a search query, a difference operator A may, for example, be computed and compared against a suitable threshold. For example, at times, A greater than a threshold may indicate that it may be useful to add a search query to a corpus of related content covering a suitable time period. By way of example but not limitation, in one particular simulation or experiment, it appeared that a threshold of about 0.01 may prove beneficial for determining whether a search query may add incremental value, such as with respect to a suitable feature employed to locate and/or retrieve related content (e.g., TF-IDF, etc.). At times, a determination may, for example, be made based, at least in part, on ranking or scoring a number of search queries via one or more suitable approaches, statistical or otherwise. Thus, consider:

$$Δ = \{ \begin{matrix}1 & if dfr ( i ) = 0 \\ \frac{Sn - So}{So} & otherwise\end{matrix} \\ Where So = {\sum }_{i = 1}^{nterms} \frac{fr ( i , d )}{tfr ( i )} * \frac{1}{dfr ( i )} \\ Sn = {\sum }_{i = 1}^{nterms} \frac{( fr ( i , d ) + 1 )}{( tfr ( i ) + 1 )} * \frac{1}{dfr ( i )} ,$$

where d denotes a search query document for merging queries on a per-question basis. As seen, a search query may have nterms terms with term in the search query identified as tᵢ. Term frequencyfr(i,d) represents a number of times tᵢ occurs in a search query document d; tfr(i) denotes a total term frequency of tᵢ in a corpus of related content; and dfr(i) denotes a number of unique search query documents where term tᵢ occurs. Accordingly, respective search query documents comprising suitable search queries, such as collected and/or processed on a monthly basis, for example, may be merged so as to generate an electronic representation of a corpus of referred content. In some instances, merging search queries, such as discussed above, for example, may facilitate or support generating and/or maintaining a corpus at a manageable or otherwise suitable size. Of course, details relating to collecting, processing, merging, etc. search queries are merely examples to which claimed subject matter is not limited.

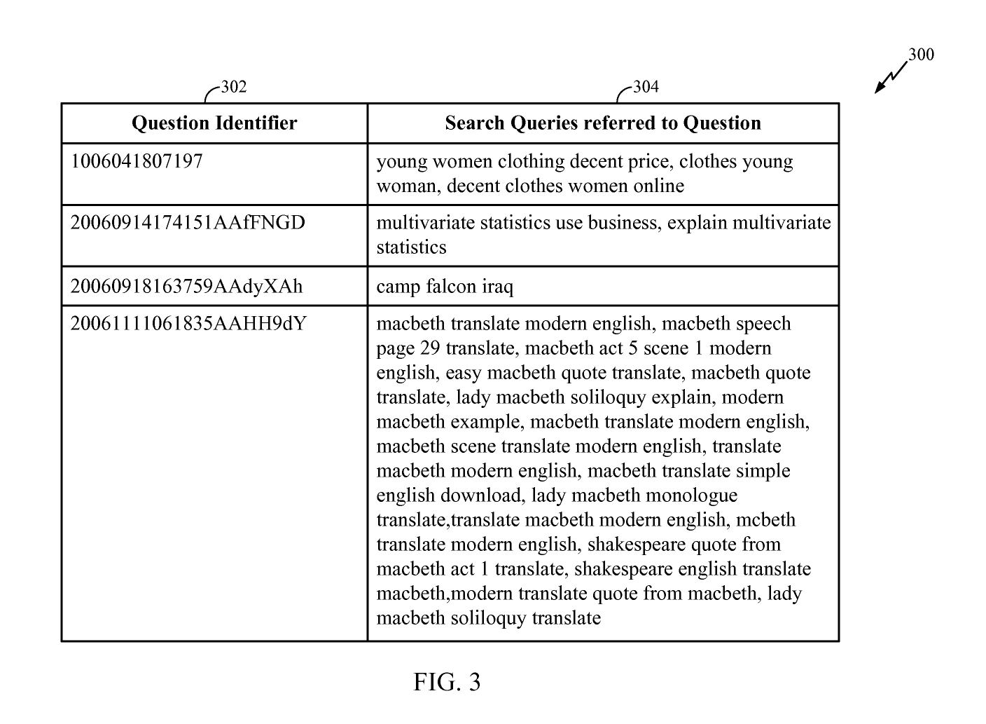

As was indicated, in some instances, an electronic representation of a corpus of related content referred via a search query may comprise a suitable search index, such as an inverted index 300 illustrated in FIG. 3, for example. As seen, inverted index 300 may include a number of searchable features, such as a feature 302 identifying and/or representing content of interest, such as a particular question, for example, and a feature 304 comprising search queries (e.g., normalized, comma-separated, etc.) that refer a user to that content. Question identifiers may comprise and/or be represented via any suitable combination of text, numbers, characters, or the like. Of course, details relating to inverted index 300 are merely examples to which claimed subject matter is not limited. An electronic representation of a corpus of related content, such as inverted index 300, for example, may be used, at least in part, to facilitate or support recirculation of on-line traffic within a special purpose search engine, such as by decreasing or averting user exits towards a general purpose search engine, for example.

Thus, referring back to process 200 of FIG. 2, at operation 204, based, at least in part, on an electronic representation of a corpus of related content, on-line traffic may, for example, be recirculated, such as within a special purpose search engine. More specifically, in an implementation, with respect to an incoming search query, such as a search query inputted or entered via a special purpose search engine, for example, one or more suitable text processing operations (e.g., normalization, stemming, stop word removal, etc.) may be performed. Based, at least in part, on an incoming search query, a suitable search index (e.g., inverted index 300 of FIG. 3, etc.) may, for example, be accessed and/or searched, and one or more content identifiers (e.g., Question IDs, etc.) may be located and/or retrieved. As was indicated, in some instances, a TF-IDF-type feature may, for example, be employed, in whole or in part, to locate and/or retrieve one or more content identifiers, though claimed subject matter is not so limited. For example, at times, a BM25-type or any other suitable feature, statistical or otherwise, may be used or otherwise considered. TF-IDF, BM25, or like features are generally known and need not be described here in greater detail. Based, at least in part, on a located and/or retrieved content identifier (e.g., Question ID, etc.), corresponding on-line content related to an incoming search query may, for example, be more effectively and/or efficiently located and/or retrieved.

Following the above discussion, as a way of illustration, in one particular simulation or experiment, some examples of search queries that refer a user to content of interest, such as to a particular question via an activation of a link of interest, for example, may include those illustrated below. As seen, search queries may, for example, be grouped and/or represented via Question IDs, such as Q1, Q2, Q3, Q4, etc., as one possible implementation.
Q 1: Rentals in Bangalore, House Rent in Bangalore, Accommodation in Bangalore, 2 BHK Rent in Bangalore
Q2: Rent in Bangalore, House Rent in Bangalore
Q3: Weather in Seattle, Climate in Seattle
Q4: Samsung Galaxy S4 vs iPhone5

In an implementation, search queries may, for example, be processed in a suitable manner (e.g., normalized, tokenized, etc.) and may be used, at least in part, to generate an inverted index, such as discussed above. Thus, for an incoming search query, such as “Rental in Bangalore,” for example, an inverted index may be searched, such as via a vertical search engine associated with an on-line property, and a listing of search results may be generated and/or ranked using one or more appropriate techniques (e.g., TF-IDF, etc.). For this example, in a listing of returned search results, Q1 may, for example, be ranked higher than Q2 since both have matching text, characters, etc., but Q1 may have a higher TF-IDF score than Q2. Likewise, a search query, such as “Seattle weather” or the like, for example, inputted or entered into a special purpose search engine, may locate and/or retrieve on-line content associated with Q3. Again, search queries are illustrated as merely examples, and claimed subject matter is not limited in this regard.

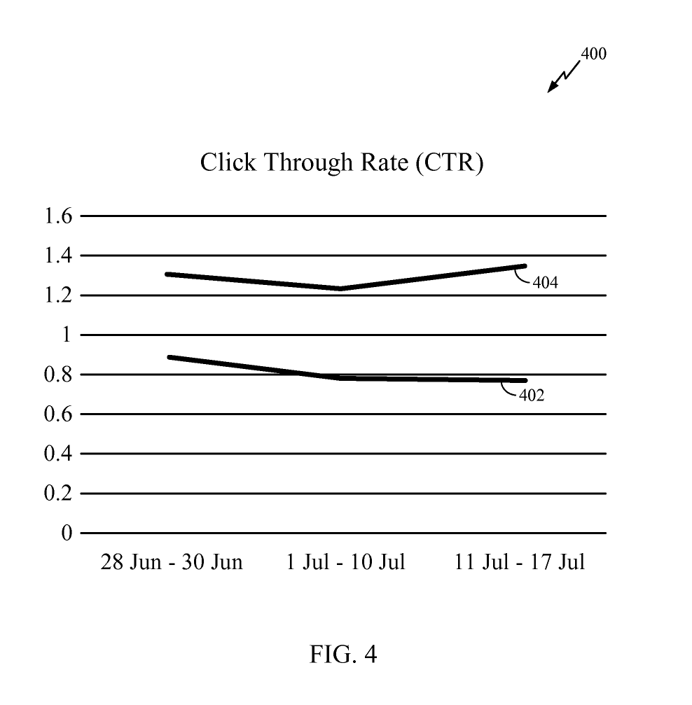

FIG. 4 is an implementation of an example plot 400 illustrating a performance of a baseline click-through rate (CTR), indicated at 402, against a CTR obtained in connection with utilizing a search index generated via a corpus of related content referred via a search query, indicated at 404. Here, for example, baseline CTR 402 may illustrate a measure attributable to a performance of a special purpose search engine utilizing a search index generated without a corpus of referred content. As seen, a statistically significant improvement in click-through rates for on-line content referred via a search query appears to be achieved. Namely, CTR 404 outperformed baseline CTR 402, as experienced and/or evidenced by users, such as with about 50% improvement, for example. This may indicate that a corpus of related content referred via a search query may, for example, prove beneficial for generating a search index and/or recirculating on-line traffic, such as within a special purpose search engine. Of course, details relating to CTRs of example plot 400 are merely examples, and claimed subject matter is not limited in this regard.

Accordingly, as discussed herein, recirculating on-line traffic, such as within a special purpose search engine, for example, may provide benefits. For example, rankings may incorporate and/or reflect user feedback (e.g., via user clicks on links of interest, etc.), thus, patentably providing an insight on changes in user preferences and/or relevance of on-line content. In addition, diversification and/or broadening of search results and/or content coverage may, for example, be achieved. Referral of content may, for example, facilitate or support identifying and/or locating duplicate content, eliminating or reducing content redundancy, etc., which may be particularly helpful for on-line properties having user-generated content (e.g., question-answering web sites, etc.). Having a more robust content coverage, better search result relevance, etc., such as while searching for content of interest within an on-line property, for example, may lead to more satisfying user experience, as was indicated, which may increase and/or positively affect a click-through or like convergence rate with respect to associated content.

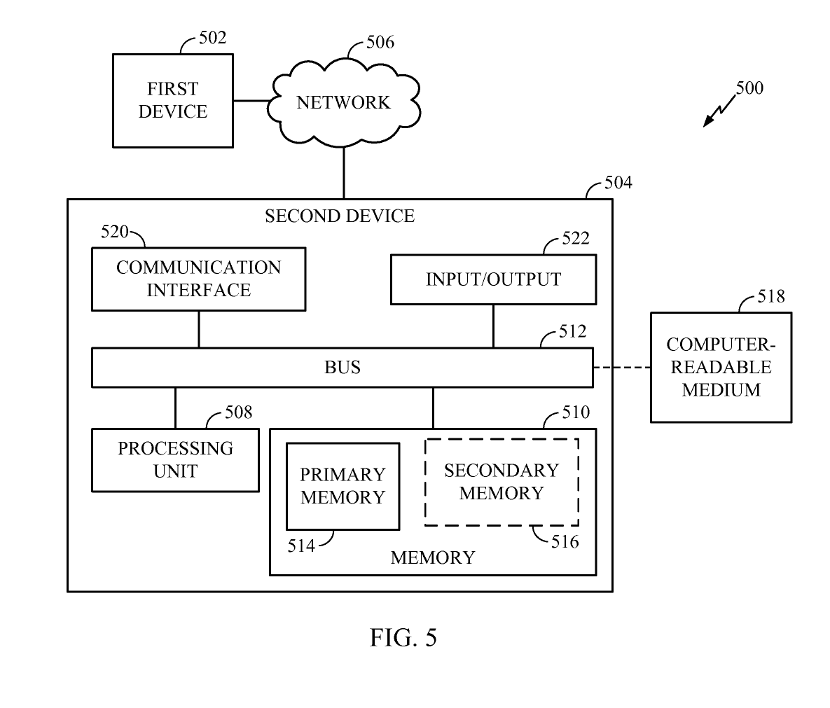

FIG. 5 is a schematic diagram illustrating an example computing environment 500 that may include one or more devices capable of implementing, in whole or in part, one or more processes or operations for recirculating on-line traffic, such as within a special purpose search engine, for example. Computing environment 500 may include, for example, a first device 502 and a second device 504, which may be operatively coupled via a network 506. In an embodiment, first device 502 and second device 504 may be representative of any electronic device, appliance, and/or machine that may have capability to exchange content or like signals over network 506. Network 506 may represent one or more communication links, processes, and/or resources having capability to support exchange and/or communication of content or like signals between first device 502 and second device 504. Second device 504 may include at least one processing unit 508 that may be operatively coupled to a memory 510 through a bus 512. Processing unit 508 may represent one or more circuits to perform at least a portion of one or more applicable computing procedures or processes. For example, although not shown, it should be appreciated that in at least one implementation processing unit 508 or like specialized devices or processors may comprise one or more processing modules capable of generating an electronic representation of a corpus of related content referred via a search query; and recirculating on-line traffic within a special purpose search engine based, at least in part, on the electronic representation of the corpus of the related content. It should also be noted that all or part of one or more processing modules may be implemented using or otherwise including hardware, firmware, software, or any combination thereof.

Memory 510 may represent any signal storage mechanism and/or appliance. For example, memory 510 may include a primary memory 514 and a secondary memory 516. Primary memory 514 may include, for example, a random access memory, read only memory, etc. In certain implementations, secondary memory 516 may be operatively receptive of, or otherwise have capability to be coupled to a computer-readable medium 518.

Computer-readable medium 518 may include, for example, any medium that may store and/or provide access to content or like signals, such as, for example, code and/or instructions for one or more devices in operating environment 500. It should be understood that a storage medium may typically, although not necessarily, be non-transitory and/or may comprise a non-transitory device. In this context, a non-transitory storage medium may include, for example, a device that is physical and/or tangible, meaning that the device has a concrete physical form, although the device may change state. For example, one or more electrical binary digital signals representative of content, in whole or in part, in the form of zeros may change a state to represent content, in whole or in part, as binary digital electrical signals in the form of ones, to illustrate one possible implementation. As such, “non-transitory” may refer, for example, to any medium and/or device remaining tangible despite this change in state.

Second device 504 may include, for example, a communication interface 520 that may provide for or otherwise support communicative coupling of second device 504 to network 506. Second device 504 may include, for example, an input/output device 522. Input/output device 522 may represent one or more devices and/or features that may be able to accept or otherwise input human and/or machine instructions, and/or one or more devices and/or features that may be able to deliver or otherwise output human or machine instructions.

According to an implementation, one or more portions of an apparatus, such as second device 504, for example, may store one or more binary digital electronic signals representative of content expressed as a particular state of a device such as, for example, second device 504. For example, an electrical binary digital signal representative of content may be “stored” in a portion of memory 510 by affecting and/or changing a state of particular memory locations, for example, to represent content as binary digital electronic signals in the form of ones and/or zeros. As such, in a particular implementation of an apparatus, such a change of state of a portion of a memory within a device, such a state of particular memory locations, for example, to store a binary digital electronic signal representative of content constitutes a transformation of a physical thing, for example, memory device 510, to a different state or thing.

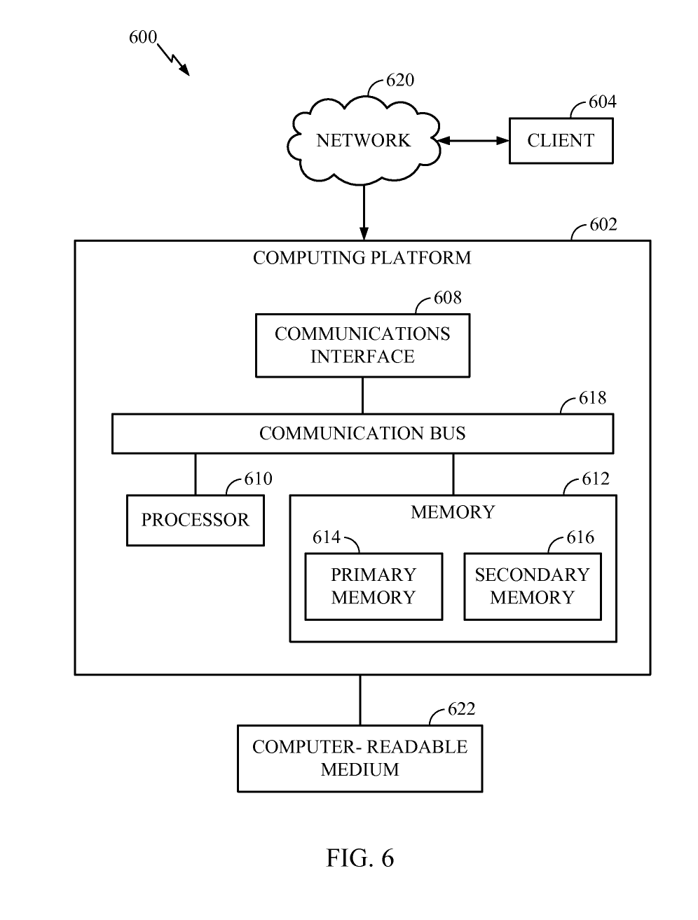

For purposes of illustration, FIG. 6 is an example of an embodiment of a computing platform 600 that may be employed in a client-server type interaction, such as described infra in connection with rendering a GUI via a device, such as a network device and/or a computing device, for example. In FIG. 6, computing platform 602 may interface with client 604, which may comprise features of a conventional client device, for example. Communications interface 608, processor (e.g., processing unit) 610, and memory 612, which may comprise primary memory 614 and secondary memory 616, may communicate by way of communication bus 618, for example. In FIG. 6, client 604 may represent one or more or more sources of analog, uncompressed digital, lossless compressed digital, or lossy compressed digital formats for content of various types, such as video, imaging, text, audio, etc. in the form physical states or signals, for example. Client 604 may communicate with computing platform 602 by way of an Internet connection via network 620, for example. Although the computing platform of FIG. 6 shows the above-identified components, claimed subject matter is not limited to computing platforms having only these components as other implementations may include alternative arrangements that may comprise additional components, fewer components, or components that function differently while achieving similar results. Rather, examples are provided merely as illustrations. It is not intended that claimed subject matter to limited in scope to illustrative examples.

Processor 610 may be representative of one or more circuits, such as digital circuits, to perform at least a portion of a computing procedure or process. By way of example, but not limitation, processor 610 may comprise one or more processors, such as controllers, microprocessors, microcontrollers, application specific integrated circuits, digital signal processors, programmable logic devices, field programmable gate arrays, and the like, or any combination thereof. In implementations, processor 610 may perform signal processing to manipulate signals or states and/or to construct signals or states, for example.

Memory 612 may be representative of any storage mechanism. Memory 612 may comprise, for example, primary memory 614 and secondary memory 616, additional memory circuits, mechanisms, or combinations thereof may be used. Memory 612 may comprise, for example, random access memory, read only memory, or one or more data storage devices or systems, such as, for example, a disk drive, an optical disc drive, a tape drive, a solid-state memory drive, just to name a few examples. Memory 612 may be utilized to store a program. Memory 612 may also comprise a memory controller for accessing computer readable-medium 622 that may carry and/or make accessible content, code, and/or instructions, for example, executable by processor 610 or some other controller or processor capable of executing instructions, for example.

Under the direction of processor 610, memory, such as memory cells storing physical states, representing for example, a program, may be executed by processor 610 and generated signals may be transmitted via the Internet, for example. Processor 610 may also receive digitally-encoded signals from client 604.

Network 620 may comprise one or more network communication links, processes, services, applications and/or resources to support exchanging communication signals between a client, such as 604 and computing platform 602, which may, for example, comprise one or more servers (not shown). By way of example, but not limitation, network 620 may comprise wireless and/or wired communication links, telephone or telecommunications systems, Wi-Fi networks, Wi-MAX networks, the Internet, a local area network (LAN), a wide area network (WAN), or any combinations thereof.

The term “computing platform,” as used herein, refers to a system and/or a device, such as a computing device, that includes a capability to process (e.g., perform computations) and/or store data in the form of signals and/or states. Thus, a computing platform, in this context, may comprise hardware, software, firmware, or any combination thereof (other than software per se). Computing platform 602, as depicted in FIG. 6, is merely one such example, and the scope of claimed subject matter is not limited to this particular example. For one or more embodiments, a computing platform may comprise any of a wide range of digital electronic devices, including, but not limited to, personal desktop or notebook computers, high-definition televisions, digital versatile disc (DVD) players and/or recorders, game consoles, satellite television receivers, cellular telephones, personal digital assistants, mobile audio and/or video playback and/or recording devices, or any combination of the above. Further, unless specifically stated otherwise, a process as described herein, with reference to flow diagrams and/or otherwise, may also be executed and/or affected, in whole or in part, by a computing platform.

Memory 612 may store cookies relating to one or more users and may also comprise a computer-readable medium that may carry and/or make accessible content, code and/or instructions, for example, executable by processor 610 or some other controller or processor capable of executing instructions, for example. A user may make use of an input device, such as a computer mouse, stylus, track ball, keyboard, or any other similar device capable of receiving user actions and/or motions as input signals. Likewise, a user may make use of an output device, such as a display, a printer, etc., or any other device capable of providing signals, generating visual or audio stimuli or other similar output stimuli for a user.

Regarding aspects related to a communications or computing network, a wireless network may couple client devices with a network. A wireless network may employ stand-alone ad-hoc networks, mesh networks, Wireless LAN (WLAN) networks, cellular networks, and/or the like. A wireless network may further include a system of terminals, gateways, routers, or the like coupled by wireless radio links, and/or the like, which may move freely, randomly or organize themselves arbitrarily, such that network topology may change, at times even rapidly. Wireless network may further employ a plurality of network access technologies, including Long Term Evolution (LTE), WLAN, Wireless Router (WR) mesh, 2nd, 3rd, or 4th generation (2G, 3G, or 4G) cellular technology, other technologies, and/or the like. Network access technologies may enable wide area coverage for devices, such as client devices with varying degrees of mobility, for example.

A network may enable radio frequency or other wireless type communications via a network access technology, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11a/b/g/n/ac, or other, or the like. A wireless network may include virtually any type of now known, or to be developed, wireless communication mechanism by which signals may be communicated between devices, such as a client device, such as a computing device and/or a network device, between or within a network, or the like.

Communications between a computing device and/or a network device and a wireless network may be in accordance with known, or to be developed cellular telephone communication network protocols including, for example, global system for mobile communications (GSM), enhanced data rate for GSM evolution (EDGE), and worldwide interoperability for microwave access (WiMAX). A computing device and/or a networking device may also have a subscriber identity module (SIM) card, which, for example, may comprise a detachable smart card that is able to store subscription information of a user, and/or is also able to store a contact list of the user. A user may own the computing device and/or networking device or may otherwise be a user, such as a primary user, for example. A computing device may be assigned an address by a wireless or wired telephony network operator, or an Internet Service Provider (ISP). For example, an address may comprise a domestic or international telephone number, an Internet Protocol (IP) address, and/or one or more other identifiers. In other embodiments, a communication network may be embodied as a wired network, wireless network, or any combinations thereof.

A device, such as a computing and/or networking device, may vary in terms of capabilities and/or features. Claimed subject matter is intended to cover a wide range of potential variations. For example, a device may include a numeric keypad or other display of limited functionality, such as a monochrome liquid crystal display (LCD) for displaying text, for example. In contrast, however, as another example, a web-enabled device may include a physical or a virtual keyboard, mass storage, one or more accelerometers, one or more gyroscopes, global positioning system (GPS) or other location-identifying type capability, and/or a display with a higher degree of functionality, such as a touch-sensitive color 2D or 3D display, for example.

A computing and/or network device may include or may execute a variety of now known, or to be developed operating systems, derivatives and/or versions thereof, including personal computer operating systems, such as a Windows®, iOS, Linux®, a mobile operating system, such as iOS®, Android®, Windows Mobile®, and/or the like. A computing device and/or network device may include or may execute a variety of possible applications, such as a client software application enabling communication with other devices, such as communicating one or more messages, such as via email, short message service (SMS), and/or multimedia message service (MMS), including via a network, such as a social network including, but not limited to, Facebook®, LinkedIn®, Twitter®, Flickr®, and/or Google+®, to provide only a few examples. A computing and/or network device may also include or execute a software application to communicate content, such as, for example, textual content, multimedia content, and/or the like. A computing and/or network device may also include or execute a software application to perform a variety of possible tasks, such as browsing, searching, playing various forms of content, including locally stored or streamed video, or games such as, but not limited to, fantasy sports leagues. The foregoing is provided merely to illustrate that claimed subject matter is intended to include a wide range of possible features or capabilities.

A network may also be extended to another device communicating as part of another network, such as via a virtual private network (VPN). To support a VPN, logical broadcast domain transmissions may be forwarded to the VPN device via another network. For example, a software tunnel may be created between a logical broadcast domain, and a VPN device. Tunneled traffic may, or may not be encrypted, and a tunneling protocol may be substantially compliant with and/or substantially compatible with any past, present or future versions of any of the following protocols: IPSec, Transport Layer Security, Datagram Transport Layer Security, Microsoft Point-to-Point Encryption, Microsoft's Secure Socket Tunneling Protocol, Multipath Virtual Private Network, Secure Shell VPN, another existing protocol, and/or another protocol that may be developed.

A network may communicate via signal packets, such as in a network of participating digital communications, A logical broadcast domain may be compatible with now known, or to be developed, past, present, or future versions of any, but not limited to the following network protocol stacks: ARCNET, AppleTalk, ATM, Bluetooth®, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring®, USB, and/or X.25. A logical broadcast domain may employ, for example, TCP/IP, UDP, DECnet, NetBEUI, IPX, Appletalk®, other, and/or the like. Versions of the Internet Protocol (IP) may include IPv4, IPv6, other, and/or the like.

It will, of course, be understood that, although particular embodiments will be described, claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example (other than software per se). Likewise, although claimed subject matter is not limited in scope in this respect, one embodiment may comprise one or more articles, such as a storage medium or storage media. Storage media, such as, one or more CD-ROMs and/or disks, for example, may have stored thereon instructions, executable by a system, such as a computer system, computing platform, and/or other system, such as a computing device and/or a network device, for example, that may result in an embodiment of a method in accordance with claimed subject matter being executed, such as a previously described embodiment, for example; although, of course, claimed subject matter is not limited to previously described embodiments. As one potential example, a computing platform may include one or more processing units or processors, one or more devices capable of inputting/outputting, such as a display, a keyboard and/or a mouse, and/or one or more memories, such as static random access memory, dynamic random access memory, flash memory, and/or a hard drive.

Thus, as illustrated in various example implementations and/or techniques presented herein, in accordance with certain aspects, a method may be provided for use as part of a special purpose computing device or other like machine that accesses digital signals from memory and/or processes digital signals to establish transformed digital signals which may be stored in memory as part of one or more content files and/or a database specifying or otherwise associated with an index, as discussed above.

Some portions of the detailed description herein are presented in terms of algorithms and/or symbolic representations of operations on binary digital signals stored within a memory of a specific apparatus and/or special purpose computing device and/or platform. In the context of this particular specification, the term specific apparatus or the like includes a general purpose computer once it is programmed to perform particular functions pursuant to instructions from program software. Algorithmic descriptions and/or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations and/or processing, such as in association with networks, such as computing and/or communications networks, for example, may involve physical manipulations of physical quantities. Typically, although not necessarily, these quantities may take the form of electrical and/or magnetic signals capable of, for example, being stored, transferred, combined, processed, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these and/or similar terms are to be associated with appropriate physical quantities and are intended to merely be convenient labels.

Unless specifically stated otherwise, as apparent from the discussion herein, it is appreciated that throughout this specification discussions utilizing terms such as “processing,” “computing,” “calculating,” “determining” or the like refer to actions and/or processes of a specific apparatus, such as a special purpose computer or a similar special purpose electronic computing device. In the context of this specification, therefore, a special purpose computer or a similar special purpose electronic computing device is capable of manipulating and/or transforming signals, typically represented as physical electronic and/or magnetic quantities within memories, registers, and/or other content storage devices, transmission devices, and/or display devices of the special purpose computer or similar special purpose electronic computing device.

The terms, “and”, “or”, “and/or” and/or similar terms, as used herein, may include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms may be used to describe any feature, structure, and/or characteristic in the singular and/or may be used to describe a plurality or some other combination of features, structures and/or characteristics. Though, it should be noted that this is merely an illustrative example and claimed subject matter is not limited to this example. Again, particular context of description and/or usage may provide helpful guidance regarding inferences to be drawn.

Likewise, in this context, the terms “coupled”, “connected,” and/or similar terms may be used generically. It should be understood that these terms are not intended as synonyms. Rather, “connected” if used generically may be used to indicate that two or more components, for example, are in direct physical and/or electrical contact; while, “coupled” if used generically may mean that two or more components are in direct physical or electrical contact; however, “coupled” if used generically may also mean that two or more components are not in direct contact, but may nonetheless co-operate or interact. The term coupled may also be understood generically to mean indirectly connected, for example, in an appropriate context.

While certain example techniques have been described and/or shown herein using various methods and/or systems, it should be understood by those skilled in the art that various other modifications may be made, or equivalents may be substituted, without departing from claimed subject matter. Additionally, many modifications may be made to adapt a particular situation to the teachings of claimed subject matter without departing from the central concept(s) described herein. Therefore, it is intended that claimed subject matter not be limited to particular examples disclosed, but that claimed subject matter may also include all implementations falling within the scope of the appended claims, or equivalents thereof.

What is claimed is:

1. A method comprising:
generating an electronic representation of a corpus of related content referred via a search query; and
recirculating on-line traffic within a special purpose search engine based, at least in part, on said electronic representation of said corpus of said related content.

2. The method of claim 1, wherein said recirculating said on-line traffic within said special purpose search engine comprises continually utilizing said special purpose search engine, at least in part, without exiting towards a general purpose search engine.

3. The method of claim 1, wherein said recirculating said on-line traffic within said special purpose search engine comprises electronically generating a listing of vertical search results.

4. The method of claim 3, wherein said listing of vertical search results comprises one or more clickable hyperlinks to said related content.

5. The method of claim 4, wherein said one or more clickable hyperlinks are representative of at least one of the following: a related question; a related answer;
or any combination thereof.

6. The method of claim 3, further comprising communicating said listing of vertical search results for display on a client device.

7. The method of claim 3, wherein said listing of vertical search results associates said related content with said search query.

8. The method of claim 1, wherein said electronic representation of said corpus of said related content referred via said search query comprises a search index.

9. The method of claim 8, wherein said search index comprises an inverted index.

10. The method of claim 1, wherein said search query is inputted via a general purpose search engine.

11. The method of claim 1, wherein said related content comprises one or more electronic documents associated with an on-line property.

12. The method of claim 11, wherein said one or more electronic documents comprises at least one of the following: a question; an answer; or any combination thereof.

13. The method of claim 11, wherein said one or more electronic documents are represented via one or more clickable hyperlinks on a web page associated with said on-line property.

14. The method of claim 1, wherein said electronic representation of a corpus of related content referred via a search query is generated via a processing module.

15. An apparatus comprising:
a computing platform, said platform including a capability to:
associate on-line content referred via a general purpose search engine with a search query inputted via a special purpose search engine based, at least in part, on said referral.

16. The apparatus of claim 15, wherein said capability to said associate said on-line content further includes a capability to access a search index in response to said search query.

17. The apparatus of claim 16, wherein said search index comprises an inverted index generated in accordance with one or more mutual characteristics of said on-line content and said search query.

18. The apparatus of claim 17, wherein said one or more mutual characteristics comprises at least one of the following: user feedback; a difference operator; a degree of relevance; or any combination thereof.

19. The apparatus of claim 15, wherein said on-line content is associated with said search query via a listing of vertical search results.

20. An article comprising:
a non-transitory storage medium having instructions stored thereon executable by a special purpose computing platform to:
generate an electronic representation of a corpus of related content referred via a search query; and
recirculate on-line traffic within a special purpose search engine based, at least in part, on said electronic representation of said corpus of said related content.
